(19) United States
(12) Patent Application Publication
(10) Pub. No.: US 2015/0349401 A1
(43) Pub. Date: Dec. 3, 2015

(54) INTEGRATED ANTENNA FOR ELECTRONIC DEVICE

(71) Applicant: Phil Nash, Xenia, OH (US)

(72) Inventor: Phil Nash, Xenia, OH (US)

(21) Appl. No.: 14/709,438

(22) Filed: May 11, 2015

Related U.S. Application Data
(60) Provisional application No. 61/992,068, filed on May 12, 2014.

(51) Int. Cl. H01Q 1/24

(52) U.S. Cl. CPC H01Q 1/24

(57) ABSTRACT

Systems and methods for providing antennas for transmission and reception of radio frequency communications. At least some implementations relate to a device and method for positioning antennas on surfaces encasing or surrounding an electronic device such as the rear of a laptop computer, smartphone, or tablet computer, or on plates, covers, and/or components that removably engage with such devices.

### RELATED APPLICATIONS

This application claims priority to U.S. Provisional Patent Application Ser. No. 61/992,068 (Attorney Docket No. 11072.728) filed May 12, 2014, entitled INTEGRATED ANTENNA FOR ELECTRONIC DEVICE, which is incorporated herein by reference in its entirety.

### BACKGROUND OF THE INVENTION

1. Field of the Invention

The present invention relates to antennas for transmission and reception of radio frequency communications. More particularly, it relates to a device and method for positioning antennas on surfaces encasing or surrounding an electronic device such as the rear of a laptop computer, smartphone, or pad computer, or on plates, covers, and components which removably engage with such devices.

2. Background and Related Art

Some computers and electronic devices in recent years include internal antennas for the broadcast and reception of RF wireless signals such as Bluetooth and WiFi. However, because of the cramped conditions and design considerations of mounting an antenna or board-engaged antenna, such antennas typically have electrical lengths of one-half wavelength at the midband frequency in the WiFi band.

Such positioning and mounting inherently cause problems with reception and transmission of RF communications. This is because many computers and electronic devices have metal cases which block or severely inhibit reception. Further the antenna being small and formed for a half wavelength or less, at the midband frequency of the radio band being used such WiFi or BlueTooth, does not perform well when the frequencies vary too far from that midband since the small antenna is adapted for best reception in that realm of the spectrum. As can be discerned, the combination of a center-weighted antenna, placed within a metal case, can combine to significantly inhibit the ability to transmit and receive RF signals on the desired frequency, especially if the area of the band being employed, is distanced from the center.

As such, severe shortcomings continue to exist in the art of antennas being employed on or with, modern electronic wireless-enabled devices and desktop computers. These shortcomings result in poor signal gain, directional transmission and reception, holes in the radiation pattern, slow digital throughput due to such weak or varying signals.

Thus, while techniques are currently available, challenges exist. Accordingly, it would be an improvement in the art to augment or even replace current techniques with other techniques.

### SUMMARY OF THE INVENTION

The present invention relates to antennas for transmission and reception of radio frequency communications. More particularly, it relates to a device and method for positioning antennas on surfaces encasing or surrounding an electronic device such as the rear of a laptop computer, smartphone, or pad computer, or on plates, covers, and components which removably engage with such devices.

Implementations of the present invention relate to an improved antenna element or array, which is configured large enough to insure high gain for exceptional bandwidth for media and computing devices. Such a device can be formed for positioning proximate to the electronic component using and transmitting an RF signal, especially with higher frequencies which are very susceptible to line loss when distanced from the using device. Still further, such a device can be able to send and receive RF signals on multiple bandwidths concurrently and should not have any holes in the radiation pattern. Further, such a device in addition to proximity to the device employing it, can also be adapted to change in polarization easily, and can be configured to allow retrofitting of existing devices lacking a decent antenna. Further, such an antenna can be part of or engageable with the housing of the electronic device it serves and is easy to retrofit so as to allow the antenna to be changed should the RF spectrum being used by the equipment change. Still further, such an antenna can perform across a wide frequency band equally well in all frequency ranges and such a device can be positionable for a larger configuration for more gain, and not be further inhibited from proper RF communications by a positioning within a computer cabinet, or electronic device housing or the like during use.

The disclosed method and device herein differs from the prior art and solves the aforementioned shortcomings, through the integration of the antenna into the computer or electronic hardware by the employment of the entire computer or electronic device structure as a principal radiating aperture. Because the disclosed device is integrated into directly into the computer hardware structure, it is configured to excite the entire hardware structure and radiates much more energy than the smaller prior art antennas. The result of this increased RF radiation is to allow successful communication to other devices at further distances from the computer or electronic devices than prior art antennas. Additionally, these communications result in a much higher throughput of data between the devices because of the significant improvement in the signal generated and received.

The provision of the disclosed integrated wideband antenna configured for reception and broadcast, in a wideband fashion equally well at all positions in the spectrum used. The RF signal can be employed for communication of data and media and digital television, using Wifi, bluetooth, and other RF frequencies for which it can send and receive concurrently. The antenna element itself, can be formed directly into metal parts of the computer or electronic device used internally or preferably into or as a component of the surrounding case. In a mode where the antenna is formed on a substrate it is mounted to surface of the computer or case to thereby take advantage of the larger area to deploy a larger antenna.

In a particularly preferred embodiment, the planar antenna element is formed into conductive material of the electronic device structure, such as the metal components of the surrounding case or housing. This allows for the employment of the entire computer or electronic device structure to form the principal radiating aperture which for example, using a PC computer case, can be formed much larger than a conventional internal antenna.

Alternatively, the antenna herein can be formed on components which are part of or attach to the external housing of the electronic device. Such can be for example, the metal or the plastic fan cover or shroud which will allow for subsequent installation of new or differing antennas built into such an engageable component should the frequencies or other spectrum needs change for the device to which it engages.

In another preferred mode, taking advantage of the large areas of planar or other housing components for electronic devices, the antenna can be formed in a large format in a wideband configuration on a dialectic-separated portion of the housing, or formed on a substrate engageable with a non-metal housing. This mode may work well with electronic devices having non-conductive cases or housings and still allow for a substantially larger and more wideband antenna to be included as part of the structure of the component.

A particular favorite for use is an antenna formed into a conducting structure, or engaged to a housing or cover of the electronic component itself. The antenna shown herein is a formed horn radiator which works well across a range of frequencies. As formed, such depends from a widest point configured for the lowest frequency received, to a narrowest point yielding the highest frequency reception.

Along a cavity pathway extending inward from the mouth defined by distal ends of the surface edges forming element halves, the cavity narrows in cross sectional area. The formed cavity thus at the mouth is at a widest point between the two distal end points and narrows along facing edges to a narrowest point.

As shown herein, this mouth and narrowing cavity may be formed directly into the components forming an electronic device such as the case or housing surrounding interior components. It can also be formed into engageable metal components or covers to yield a radiating element which is not inhibited by a surrounding metal case and with wideband reception and transmission.

Or, as noted, in another mode it may be formed of conductive material placed on a non-conductive surface of the electronic device, or insulated from surrounding conductive material, to form the antenna, or it can be formed as part of a wall of the case or housing.

The wideband antenna shown has a cavity which from the narrow point in the antenna formation extends in a passage to a tail portion which curves in its formation within the metal component of the electronic device, components or as adhered thereto, to extend to a distal end within the one side wherein a pickup is engaged for communication of received signals and signal being transmitted by the formed antenna. The area occupied by this tail section has a direct effect upon the antenna impedance and as such is adjusted for area for impedance matching purposes.

The planar horn wideband antenna, or a plurality of such wideband antennas may be formed into the metallic components of the computing or electronic device or the surrounding case or housing. When formed into the sidewall of a casing or cover to an electronic device, should closure or sealing of the formed areas of the mouth and narrowing sections be desired, dialectic can be fitted into the area of formation of the horn antenna to seal the electronic components in the housing. This will yield a large area antenna, not surrounded by a metal conducting case for a significant gain in signal over conventional internal antennas.

Of course those skilled in the art will realize that cross section and length of the two side edges defining the horn formed by the cavity formed into the casing or components of the electronic device as well as the size and shape of the box-end surface area, may be adjusted to fine tune impedance matching, increase gain in certain frequencies, or for other reasons known to the skilled, and any and all such changes or alterations of the depicted antenna element as would occur to those skilled in the art upon reading this disclosure are anticipated within the scope of this invention.

It must further be noted that although the present invention is portrayed as a single antenna element, or two elements formed into the structure of the electronic device or computer such as their housing or case, it is within the scope of the invention that the antenna be employed as an array of such antenna elements formed into one or a plurality of layers of conductive material on the substrate, either in a vertical disposition or horizontal disposition and positionable for either horizontal or vertical polarization of RF signals received and/or broadcast.

With respect to the above description, before explaining at least one preferred embodiment of the herein disclosed antenna invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other antenna structures, and methods and systems for carrying out the several purposes of the present disclosed device. It is important, therefore, that the claims be regarded as including such equivalent construction and methodology insofar as they do not depart from the spirit and scope of the present invention.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 shows a mode of the device and method wherein the antenna has been formed directly into a large area of a surrounding case or housing of an electronic device such as a computer or server;

FIG. 2 shows another preferred mode of the device formed by the method herein through formation into a housing-engageable component such as a fan cover;

FIG. 3 depicts the ease of replacing or changing the polarization scheme of the antenna of FIG. 2 when so formed into an engageable component, by removing and rotating the engageable component in its engagement with a housing; and

FIG. 4 depicts a fan cover having a metal perimeter section, and a central portion in a surrounded engagement with the metal perimeter for formation or engagement of an antenna therein.

### DETAILED DESCRIPTION OF THE INVENTION

The present invention relates to antennas for transmission and reception of radio frequency communications. More particularly, it relates to a device and method for positioning antennas on surfaces encasing or surrounding an electronic device such as the rear of a laptop computer, smartphone, or pad computer, or on plates, covers, and components which removably engage with such devices.

Now referring to drawings in FIGS. 1-4, wherein similar components are identified by like reference numerals, there is seen in FIG. 1 an exemplar of a mode of the device 10 and method herein wherein the antenna 12 has been formed directly into a large area of a metal case or housing 14, surrounding an electronic device 16 such as a computer or server or television or the like which employs RF communications such as WiFi or Bluetooth.

It is one of the primary objectives of the disclosed method and invention to make employ the large areas of the metal material which encase and surround electronic devices such as computers and computer servers and other electronic devices as an antenna directly exposed to the surrounding area of the housing 14. In doing so, an antenna 12 of considerable size may be operatively positioned, exposed to the exterior to the surrounding housing 14, and operatively engaged to the interior electronic component requiring wireless communications.

Further, when formed into a large area of a housing 14, the method and apparatus herein allows for the inclusion of multiple antennas 12 and 12a for example, using the housing 14 and suitable for differing RF bands if such is desirable, and in different polarizations, instead of a single antenna 12.

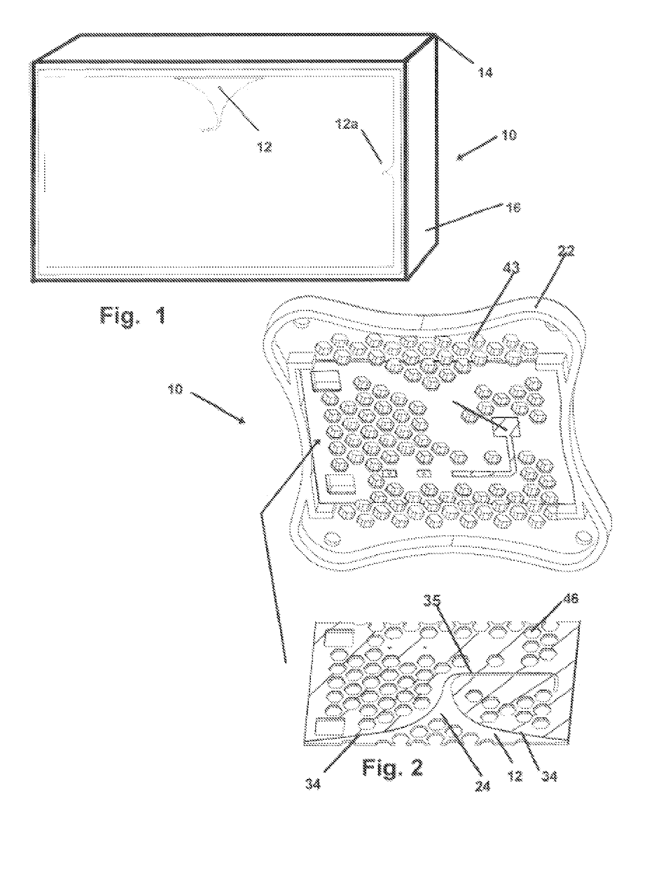

Shown in FIG. 2, is a mode of the device 10 formed employing the method herein, to yield the antenna 12 as part of and directly exposed to the exterior of an electronic device housing 14 or case, shown as part of a fan cover 22. Such fan covers 22 are engageable components which are frequently engaged with the housing 14 surrounding electronic devices to allow air passage therethrough. However any engageable component attachable to a housing 14 can serve the same purpose and such is anticipated. Shown adjacent to the cover 22 in FIG. 2, is the formed antenna 12 which may be formed by edges 34 cut directly into the metal surface of the cover 22. The opening between the edges 34 forming an antenna 12 can be filled with a dialectic 24 as shown, as or simply left open for more air passage if hole size is not an issue.

Further as disclosed herein, using a substrate and adhesive on a substrate 20, the antenna 12 may be formed to the configuration of that shown in FIG. 2, and operatively engaged at manufacture or in a retrofit of the device, to the cover 22, to enhance wireless bandwidth or off air signal reception. Such would provide significant enhancement to the operative capabilities of wireless devices in televisions, pad computers, laptops, and computer displays and other devices. For an engageable mode, the cover 22 would need to be plastic or another non-conductor in the area where the engageable antenna attaches.

The antenna 12 depicted in FIG. 2 is shown as a wideband antenna capable of excellent performance and has opposing curved side edges 34 forming a mouth or horn which declines in diameter from a widest point along the edge curves toward a center line of the formed antenna 12.

At a narrowest gap between the opposing side edges 34, a cavity 35 curves away from the center of the formed antenna 12 in a curved or serpentine extension where a feedline 36 is operatively engaged. The edges 34 cut into the conductive material, define a mouth or horn which is configured at a widest point to operatively receive and transmit on a lowest frequency received, and curve to decline the distance between the side edges 34 to the narrowest point of the mouth or horn which is configured to send and receive RF at the highest frequency. As shown in FIG. 1, one or a plurality of antennas 11 formed into conductive material can be formed to yield transmission and reception capabilities in different bands or frequencies such as WiFi, BlueTooth, and Cellular for example or in differing polarizations as shown in FIG. 1. Additionally as noted, when the metal of the housing 14 or of an engageable component such as a fan cover 22 is employed and has the antenna formed by formation of edges 34, the void between the edges 34 may be filled with a dialectic to maintain the separation provided by the housing 14 for the internal electronics from the exterior of the housing.

It should be noted that if the fan cover 22 of FIG. 2 is formed of plastic or a dialectic material and the antenna 12 is formed of conductive material on a substrate which is configured for operative engagement to a nonconductive section of a fan cover 22, it need not be using adhesive. Alternatively, a perimeter portion of the formed antenna 12 can be configured to engage with mating portions or mounts on the formed in the fan cover 22. Apertures 46 such an engageable antenna 12 may be formed in positions to register with apertures 43 communicating through the cover 22 to provide for air passage.

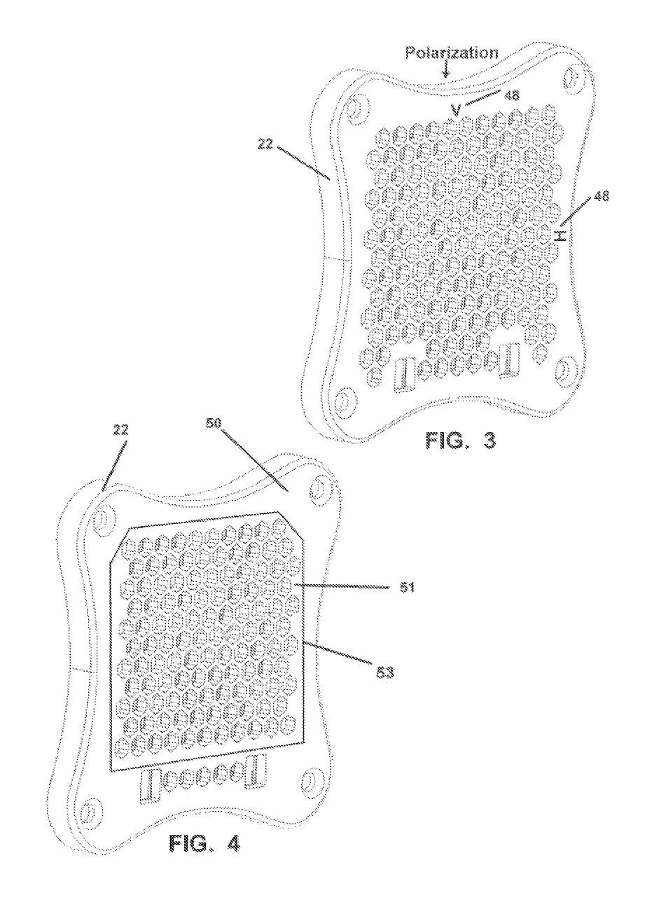

FIG. 3 depicts an exterior view of an engageable component such as the fan cover 22 as it might be employed with the antenna 12 of FIG. 2. As shown the cover 22 has a perimeter which is adapted to allow mounting in any horizontal or vertical position of the cover 22 relative to the housing 14 on which it engages. In this mode, indicia 48 may be placed on the cover 22 and housing 14 of the electronic device to which it engages to allow the user to rotate the cover 22 and thereby change the polarization of the antenna 11 between horizontal and vertical.

FIG. 4 depicts a fan cover 22 such which is formed with a metal or other perimeter section 50 surrounding a central section 51 of plastic or similar non-conductive or dialectic material which would carry the antenna 12 on a substrate and engaged therewith as noted earlier. This mode of the device 10 with the cover 22 is especially useful where the structural integrity of the housing 14 of the electronic device to which the cover 22 attaches, needs the strength of metal to maintain structural integrity.

Also this mode may be employed with either a plastic or metal perimeter and removable and replaceable central sections 51 where each has a different antenna 12 mounted thereon, to allow the antenna 12 to be changed by engaging a different central section 51. Additionally, the antenna 12 formed within the central section 51 may also be formed as an antenna 12 directly into a metal central section 51 sized to fit as the central section 51, but insulated from the surrounding perimeter using a dialectic insulator around the perimeter edge 53 of the metal central section 51.

Formation of the central section 51, either in the plastic or metal mode of the central section 51, with the antenna 12 either integral to or engaged with the central section 51, allows for changing the antenna 12 formed into or engaged with the central section 51, with a new configuration if needed.

While all of the fundamental characteristics and features of the surface mounted antenna system and method herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

Thus, as discussed herein, the embodiments of the present invention embrace antennas for transmission and reception of radio frequency communications. More particularly, it relates to a device and method for positioning antennas on surfaces encasing or surrounding an electronic device such as the rear of a laptop computer, smartphone, or pad computer, or on plates, covers, and components which removably engage with such devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An antenna element formed integral to or as part of a housing surrounding an electronic device and being directly exposed to the area surrounding said housing.

2. A method of forming an antenna of claim 1 into or as a component of a housing of an electronic device.
